(19) United States
(12) Patent Application Publication
(10) Pub. No.: US 2012/0285873 A1
(43) Pub. Date: Nov. 15, 2012

(54) ORGANIC WASTE MANAGEMENT SYSTEM

(76) Inventors: John BRENAN, West Lafayette, IN (US); Heather Brenan, West Lafayette, IN (US)

(21) Appl. No.: 13/468,770

(22) Filed: May 10, 2012

Related U.S. Application Data
(60) Provisional application No. 61/518,668, filed on May 10, 2011.

(51) Int. Cl. B01D 43/00

(52) U.S. Cl. 210/150; 210/194; 210/188

(57) ABSTRACT

A portable, integrated organic waste management system comprises a receiver for receiving waste organic material, a particle size reducer for grinding waste organic material, a first pump for pumping ground waste organic material, a storage vessel for receiving pumped ground waste organic material in the form of a slurry, and a second pump for recirculating ground waste organic material in the form of a slurry. The system is contained in a portable module that can be transported to a desired site.

### CROSS-REFERENCE TO RELATED APPLICATION

This application is based upon and claims the priority of co-pending, commonly assigned U.S. Provisional Patent Application Ser. No. 61/518,668, filed May 10, 2011, incorporated herein by reference in its entirety

### FIELD OF THE INVENTION

This application is directed to systems for managing waste organic material, i.e., organic waste. More particularly, this application is directed to portable organic waste management systems comprising a particle size reducer, a pumping system, a storage vessel or tank, and a recirculation system.

### BACKGROUND OF THE INVENTION

Certain commercial establishments, for example, food handling facilities such as restaurants, delicatessens, grocery stores, and industrial food processors, produce a significant amount of organic waste, such as damaged, spoiled, or leftover food. Organic waste, which is essentially animal and/or vegetable matter, can be recycled for uses such as livestock feed, soil conditioner, fertilizer, or anaerobic digester feedstock. Such organic waste has energy potential. When organic waste is subjected to anaerobic conditions, the organic waste can be broken down into methane gas, carbon dioxide, water, and low solids. Many times, however, due to the costs and drawbacks associated with recycling organic waste, such waste is merely thrown out.

Certain procedures for the storage and/or disposal of organic waste are already known in the art. For example, Buehler, U.S. Pat. No. 5,568,996 describes a system for the storage of organic waste that is installed in a facility. The organic waste is ground up and stored in an underground storage tank, and at different times the processed organic waste is suctioned out of the storage tank into a tanker for disposal.

Other systems for the disposal of dry and/or wet organic waste are disclosed in, for example, U.S. Pat. Nos. 6,117,671, 6,267,497, 6,299,380, and 7,144,550 and U.S. Published Patent Applications Nos. 2009/0081013 and 2011/0238600. However, all the systems disclosed require significant structures to process and store organic waste.

### OBJECTS OF THE INVENTION

It is an object of the invention to provide a novel method and system for managing, recycling, and/or disposing of organic waste.

It is also an object of the invention to provide a portable organic waste management system for disposing of, recycling, and/or managing organic waste that comprises an integral unit that can be placed adjacent to a food processing or food handling facility.

It is a further object of the invention to provide a portable organic waste management system for disposing of, recycling, and/or managing organic waste that comprises an integral unit that can be placed adjacent to a food processing or food handling facility and is able to functionally communicate with the facility.

It is a yet further object of the invention to provide a portable organic waste management system for disposing of, recycling, and/or managing organic waste which comprises a particle size reducer, a pump, a storage vessel, and a recirculation system.

It is a yet further object of the invention to provide a portable organic waste management system for disposing of, recycling, and/or managing organic waste which comprises a particle size reducer, a pump, a storage vessel, and a recirculation system in an integral structure.

It is a yet further object of the invention to provide a portable anaerobic digester system for disposing of, recycling, and/or managing organic waste that comprises an integral unit that can be placed adjacent to a food processing or food handling facility.

It is a further object of the invention to provide a portable anaerobic digester system for disposing of, recycling, and/or managing organic waste that comprises an integral unit that can be placed adjacent to a food processing or food handling facility and is able to functionally communicate with the facility.

It is a yet further object of the invention to provide a portable anaerobic digester system for disposing of, recycling, and/or managing organic waste which comprises a particle size reducer, a pump, a storage vessel, and a recirculation system.

It is a yet further object of the invention to provide a portable anaerobic digester system for disposing of, recycling, and/or managing organic waste which comprises a particle size reducer, a pump, a storage vessel, and a recirculation system in an integral structure.

These and other objects of the invention will become more apparent from the discussion below.

### SUMMARY OF THE INVENTION

According to the invention, waste organic material is processed in an organic waste management system. The organic waste management systems described herein comprise a particle size reducer, such as a mill, grinder, or paddle finisher, to reduce the particle size of organic waste. The size-reduced organic waste forms a slurry, optionally in admixture with other processed organic waste. The particle size reducer is incorporated within or in communication with a receiver, such as a hopper, for initially receiving organic waste. The organic waste slurry is pumped to a storage vessel, where the slurry is introduced into the storage vessel or tank, preferably through aerating nozzles, which reduce particle size and/or mix contents. Organic waste slurry from the storage vessel or tank is recirculated through a recirculation system to the receiver or the particle size reducer, where the recirculated slurry admixes with initial organic waste material.

In one aspect of the invention, slurry from the pump, the storage vessel or tank, or both the pump or storage vessel or tank, is pumped up through aerating nozzles in the sides, top, or sides and top of the storage vessel to aerate the slurry. Optionally there may be an in-system pump to remove slurried organic materials for transport in a liquid state. This prevents bridging.

In another aspect of the invention, the receiver, particle size reducer, pump, and storage vessel are all integrated into a single portable structure or module that can be positioned adjacent to a food processing or food handling facility. Organic waste can be dropped or placed in a hopper or receptacle that directs or transports the organic waste to a particle size reducer. The system is a “plug-n-play” system in that the only external connection necessary is an electrical connection.

In another aspect of the invention, slurry is recycled to the particle size reducer. Also, slurry is constantly circulated and recirculated to keep the processed waste in a mechanical emulsion, to prevent clumping.

Typical organic waste material comprises plant or animal foodstuffs, including, but not limited to, bread, vegetables, meat, and the like.

An organic waste management system according to the invention may have at least one sensor and/or detector to measure and/or monitor variables such as oxygen content, temperature, pH, pressure, and/or other parameters. In addition, there may be a sensor or detector to determine the level of organic waste slurry in the storage vessel. In at least one embodiment of the invention, organic waste slurry in a storage vessel will be emptied into, for example, a tanker or other vehicle either on a regular basis or when certain fluid levels of slurry are reached, or both.

The invention herein is broadly characterized as an organic waste management system. However, there are effectively at least two different types of systems. In a first type of system, a portable organics management, or “POM”, system, organic waste is treated in the manner described above in an aerobic environment to produce an organic waste slurry, where odors and gases are scrubbed, filtered, or otherwise released to the air. In an aerobic environment, aerobic bugs generate organic acids that lower the pH of the slurry to a range of from about 3.5 to about 4. When the pH is in this range, there is no fermentation, and the energy value of the slurry is preserved. Also, there is less need to empty the storage vessel, so that there will be fuller loads. The resulting slurry can be taken to a co-digestive facility for further treatment.

In a second type of system, a portable anaerobic digester, or “PAD”, system, a waste slurry is treated anaerobically in a closed vessel, where gases produced are treated and recycled or used, for example, to operate a generator. The pH of the slurry is maintained anaerobically at a pH of about 4.5

Organic waste slurry prepared according to the invention can be used in any way that typical waste organic effluent is used. The waste slurry can be stored for off-site transportation and management. Typical uses include composting additives, or anaerobic digestion or other forms of recycling.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a schematic representation of a lateral, substantially cross-sectional view of one embodiment of the invention;

FIG. 2 is a schematic representation of a top, substantially cross-sectional view of the embodiment of the invention shown in FIG. 1;

FIG. 3 is a schematic representation of a rear, substantially cross-sectional view of the embodiment of the invention shown in FIG. 1;

FIG. 4 is a schematic representation of a lateral, substantially cross-sectional view of another embodiment of the invention;

FIG. 5 is a schematic representation of a lateral, substantially cross-sectional view of another embodiment of the invention; and

FIG. 6 is a schematic representation of a top view of the embodiment of the invention shown in FIG. 5.

### DESCRIPTION OF THE PREFERRED EMBODIMENTS

Preferred embodiments of the present invention will now be described with reference to the drawings. Identical elements in the various figures are designated with the same reference numerals.

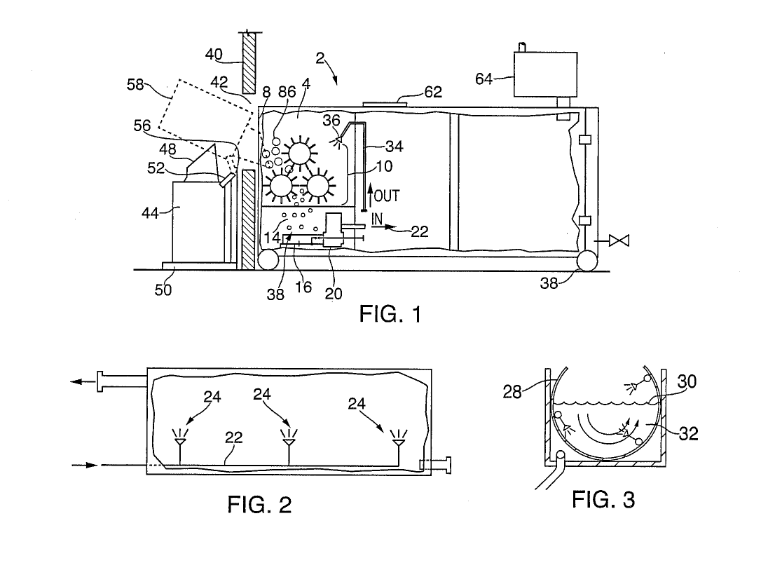

According to the embodiment of the invention set forth in FIGS. 1-3, a POM system module 2 comprises a receiver 4 for receiving organic waste material 6. Receiver 4 has an opening, such as a side opening 8 or a top opening (not shown), whereby organic waste material can be introduced. Receiver 4 comprises a one- or two-stage particle size reducer 10, such as a mill, grinder, paddle finisher, or other appropriate mechanical device for reducing particle size.

Processed organic waste material 14 having a particle size from about 25 mm to about 200 mm, preferably from about 50 mm to about 100 mm, optionally in a slurry, drops from receiver 4 into an input 16 for a grinder pump 20. Pump 20 pumps the slurry through pipe system 22 to aerating nozzles 24, which nozzles 24 are positioned at different points within storage vessel or tank 28. Nozzles 24 could be positioned above and/or below a surface 30 of liquid slurry 32 within storage vessel 28, and there can be as many nozzles 24 as needed, for example, from 2 to as many as 20 or more. Nozzles 24 have at least two functions, to maintain aerobic conditions and to prevent clumping by further particle size reduction.

Optionally storage tank 28 may contain a chemical emulsifier, such as one or more of typically used and commercially available organic surfactants, to further reduce particle size and to make the slurry more flowable. Also, there could optionally be a solids separator system (not shown) within storage vessel 28 or elsewhere within module 2 to remove larger size particles.

Slurry from storage vessel 28 is recirculated through recirculation line 34 to one or more nozzles 36. The slurry then admixes with organic waste material 6, wherein the recirculated slurry can function as a mechanical emulsifier and prevent clumping of the organic waste particles.

POM system module 2 is a self-contained, integral structure that can be delivered as a single unit to a desired site. Preferably module 2 is configured to be slid off a flat bed truck at a site. In another embodiment, module 2 may have wheels, casters, or the like 38 so that it can be towed or pushed into position. An advantage of the invention herein is that there is virtually no installation necessary at a site, with the exception of an electrical connection. Such an installation can be characterized as “plug-n-play”.

In FIG. 1, module 2 is positioned adjacent to a building wall 40 that has an opening 42. A trash receptacle 44 with a top opening 48 is received on a loading platform 50. Loading platform 50 has a pivot member 52 so that loading platform 50 can be pivoted manually or mechanically around pivot point 56 to dotted lines 58, whereupon organic waste 6 from trash receptacle 44 falls into receiver 4.

Storage vessel 28 in module 2 is a closed space that may have one or more access points or manways 62. In addition, there are one or more vent systems 64 positioned above and in communication with storage vessel 28, that preferably have an odor control capability. Typically ozone generating systems are used to control odor. A key odor control mechanism involves causing or allowing the pH of the slurry to be less than 4.5, preferably about 3.5 to about 4, which eliminates most of the odor.

A rear section chamber 66 of module 2 preferably has at least one airtight access door for accessing the interior of module 2. Also, a pipe 70 in fluid communication with storage vessel 28 has a valve 72, for transfer of slurry to a transportation vehicle such as a tanker. Dependent upon the configuration, chamber 66 may have pumping/piping for the slurry circulation or recirculation systems as well as one or more additional pumps, as needed.

In another embodiment of the invention, receiver 4 may have a top opening (not shown), with or without a closable lid or top (not shown), so that organic waste can be delivered to receiver 4 from above. For example, module 2 may be positioned adjacent a building where organic waste is thrown or dropped into a chute that empties into receiver 4.

Storage vessel 28 may have a volume of from about 500 to 4000 gallons, preferably from about 1000 to about 3500 gallons. A working module 2 will have at least 100 gallons of slurry, after slurry is removed and transported to another location. Typically organic waste slurry is taken to a co-digestive facility, a treatment plant, or a PAD system. The slurry is treated anaerobically, which requires flowable material with small particle size, as is prepared according to the invention. Anaerobic treatment breaks the slurry down into methane, carbon dioxide, water, and low solids, which can be useful for, for example, soil conditioner or fertilizer.

In another embodiment of the invention, there could be an initial separation unit where useful organic waste material is separated from larger particle size and/or larger molecule material. For example, a screw conveyor may transport material to a high speed separator, which separates out the useful organic waste material to be processed according to the invention. The larger particle or larger molecule material may be re-used in dried form.

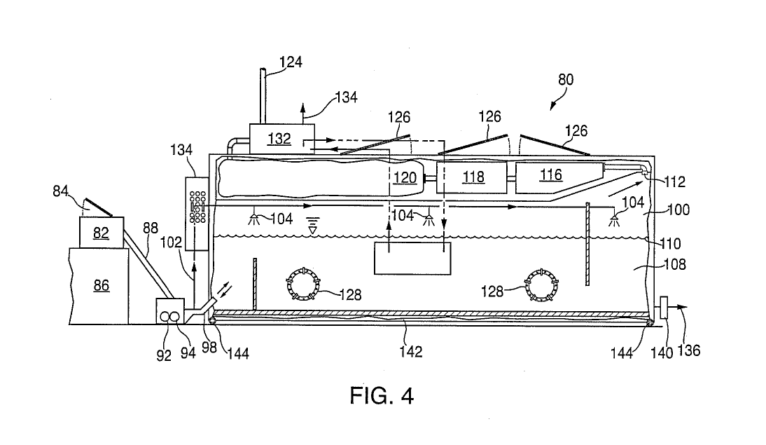

In FIG. 4, a PAD system module 80 comprises a safety hopper or receiver 82 for receiving organic waste 84. Here, safety hopper 82 is positioned on a loading dock 86 of a food processing facility (not shown). A screw drive 88 transports organic waste 84 from safety hopper 82 to a recirculation tank 92 that has a grinder pump 94 (with a clean out), for grinding the organic waste to a desired particle size. One portion of recirculation tank 92 comprises piping 98 whereby organic waste slurry flows into a storage vessel or tank 100 and slurry from storage vessel 100 flows into recirculation tank 92. Slurry from recirculation tank 92 also is pumped through recirculation line 102 to aerating nozzles 104, whereby aerated slurry is dispersed into slurry 108 within storage vessel 100, preferably above slurry line 110.

In the embodiment shown in FIG. 4, gases from the processed organic waste slurry 108 exit through an upper opening 112 that is in fluid communication with a gas compressor 116, a gas filter 118, a pressure vessel 120, and a generator 132 that is fueled by the gases. Module 80 also has manways or hatches 126 and 128. Generator 132 has connections 134 to a facility electrical panel or storage grid (not shown)and an exhaust 124. A weather safe control panel 134 is easily accessible to an operator. A drain 136 optionally has a basket screen filter 140. Optionally module 80 has a support chassis 142 with wheels 144 so that module 80 can be rolled off a flat bed delivery vehicle (not shown).

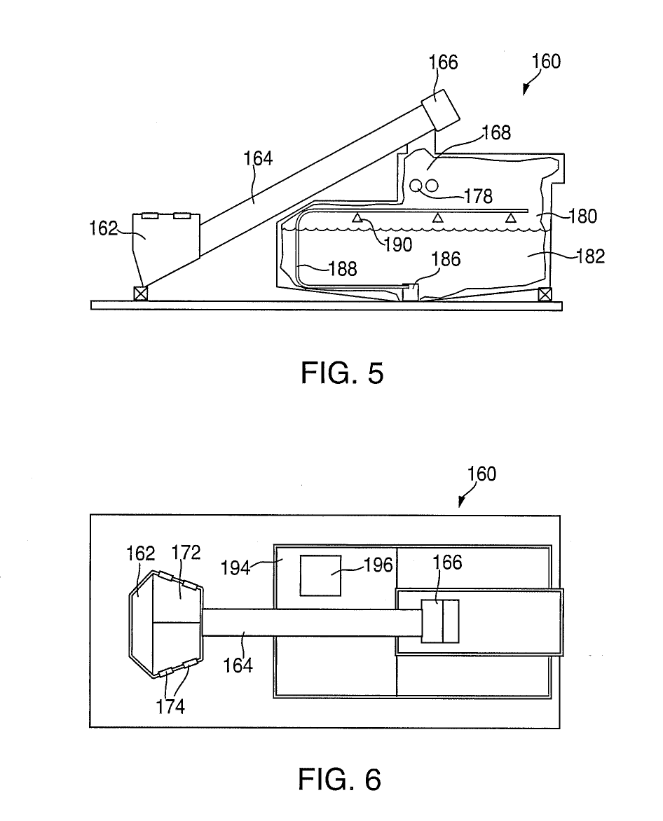

In another embodiment of the invention, as shown in FIGS. 5 and 6, a POM system module 160 comprises a receiver 162 for receiving organic waste material, a screw drive 164 for transporting organic waste to a grinding chamber 168. Screw drive 164 is powered by motor 166. Receiver 162 comprises doors 172 that open and close around hinges 174 to open receiver 162 to receive organic waste.

Grinding chamber 168 comprises one or more particulate grinders or grinding pumps 178 that grind the organic waste into the desired particulate size, as described above. Ground particulate waste can fall into, or be pumped into, vessel or tank 180. Tank 180 comprises slurry 182 that is recirculated through pump 186 and piping 188 to aerobic nozzles 190 and, optionally, grinding chamber 168. The upper surface 194 of module 160 comprises at least one manway or hatch 196.

The module 160 shown in FIGS. 5 and 6 is 7′ 10″ wide×20′ 6.25″ long×10′¼″ tall, made of 3/16″ coated steel, with an empty weight of about 7 tons. The tank or vessel has a maximum capacity of about 3500 gallons, and the module is capable of processing about 4 to about 8 tons of organic waste per hour.

The embodiments of the invention described above comprise various commercially available components and materials as well as some that have been customized. Useful pumps and grinder pumps include one or more of commercially available pumps. Useful screw drives include models 15″ cutting screw conveyor (reversible). Useful piping includes commercially available PVC, copper, FRP, or steel pipes having an i.d. or o.d. dependent upon the requirements of the system. The vessels, receivers, and other surfaces are configured from rigid polymers or steel having a suitable thickness.

There has thus been shown and described a novel organic waste management system which fulfills all the objects and advantages sought therefore. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A portable, integrated organic waste management system comprising:
a receiver for receiving waste organic material;
a particle size reducer for grinding waste organic material;
a first pump for pumping ground waste organic material;
a storage vessel for receiving pumped ground waste organic material in the form of a slurry; and
a second pump for recirculating ground waste organic material in the form of a slurry,
wherein the system is contained in a portable module that can be transported to a desired site.

2. The waste management system of claim 1, wherein the receiver comprises the particle size reducer.

3. The waste management system of claim 1 which comprises a transport system to transport the waste organic material from the receiver to the particle size reducer.

4. The waste management system of claim 1, wherein the transport system is a screw drive.

5. The waste management system of claim 1, wherein slurry is recirculated to the receiver.

6. The waste management system of claim 1, wherein slurry is recirculated to the particle size reducer.

7. The waste management system of claim 1, wherein the slurry is aerated into the storage tank through aerating nozzles.

8. The waste management system of claim 1 which comprises a gas management system for treating gases emanating from the storage tank.

9. The waste management system of claim 1, wherein the slurry is maintained in an aerobic environment.

10. The waste management system of claim 9, wherein the slurry is maintained at a pH of from about 3.5 to about 4.

11. The waste management system of claim 1, wherein the slurry is maintained in an anaerobic environment.

12. The waste management system of claim 11, wherein the slurry is maintained at a pH of about 4.5.

13. The waste management system of claim 11 which further comprises a generator.

14. The waste management system of claim 13, wherein the generator is fueled by gases from the slurry.
